(19) United States
(12) Patent Application Publication
(10) Pub. No.: US 2026/0154691 A1
(43) Pub. Date: Jun. 4, 2026

(54) SYSTEMS AND METHODS FOR AI/ML-BASED ENHANCEMENT AND RESOLUTION OF SUPPORT REQUESTS

(71) Applicant: Verizon Patent and Licensing Inc., Basking Ridge, NJ (US)

(72) Inventors: Rohit Goyal, Hyderabad (IN); Srilam Suresh Kanakavalli, Coimbatore District (IN); Dhananjayan Sp, Vellore District (IN)

(73) Assignee: Verizon Patent and Licensing Inc., Basking Ridge, NJ (US)

(21) Appl. No.: 18/963,866

(22) Filed: Nov. 29, 2024

(51) Int. Cl. G06Q 30/015

(52) U.S. Cl. CPC G06Q 30/015

(57) ABSTRACT

A system described herein may maintain a plurality of support classification models and a plurality of resolution action models; determine respective associations between the plurality of support classification models and the plurality of resolution action models; receive a plurality of support requests; identify a particular support classification model, of the plurality of support classification models, that is associated with a particular support request of the plurality of support requests; identify, based on the determined associations between the plurality of support classification models and the plurality of resolution action models, a particular resolution action model associated with the particular support classification model; identify one or more resolution actions associated with the particular resolution action model; generate an enhanced support request based on the one or more resolution actions; and output the enhanced support request.

### BACKGROUND

Entities such as organizations, institutions, companies, or the like, may provide support services via, for example, support tickets, call centers, or the like. The support services may relate to hardware issues such as device malfunctions or failures, network connectivity issues, application processing malfunctions or "bugs," or other types of issues. Support services relating to such issues may include, for example, receiving support requests and providing the requests to support agents, such as on a first-in-first-out basis. The support agents may examine the requests and determine potential remedial actions to perform in order to handle issues indicated in the support requests.

### BRIEF DESCRIPTION OF THE DRAWINGS

FIG. 1 illustrates an example overview of one or more embodiments described herein;

FIG. 2 illustrates an example of one or more artificial intelligence/machine learning ("AI/ML") models that may be used in accordance with some embodiments;

FIG. 3 illustrates an example user interface ("UI") that may be generated, in accordance with some embodiments;

FIG. 4 illustrates an example of communications between a support backend platform and one or more service provider systems, in accordance with some embodiments;

FIG. 5 illustrates an example process for automatically enhancing support requests, in accordance with some embodiments;

FIGS. 6 and 7 illustrate example environments in which one or more embodiments, described herein, may be implemented;

FIG. 8 illustrates an example arrangement of a radio access network ("RAN"), in accordance with some embodiments;

FIG. 9 illustrates an example arrangement of an Open RAN ("O-RAN") environment in which one or more embodiments, described herein, may be implemented; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Systems and methods described herein provide for an automated (e.g., AI/ML-based) mechanism for enhancing support requests, such as support requests related to issues such as hardware malfunctions or failures, network connectivity issues, or other issues that may be experienced or exhibited by a device. The enhancement of the support requests may include augmenting support requests with suggested solutions or other information that is determined using AI/ML techniques (e.g., based on similar requests and associated solutions determined in the past and/or other suitable information), such that a support technician may utilize the augmented information in order to better aid in resolving the issue(s) noted in the support requests. Additionally, or alternatively, the enhancement of the support requests may include automatically performing or attempting one or more solutions (e.g., potentially without human intervention), where the solutions may be identified using AI/ML techniques or other suitable automated techniques.

In this manner, the efficiency of the support system may be improved, and the user experience of users issuing support requests may be improved. Further, since the solutions identified are identified using AI/ML techniques, the potential for human error may be minimized or eliminated in the identification of solutions for a given type of issue. Additionally, presenting proposed solutions, automatically determined via AI/ML techniques, may serve as a training mechanism for inexperienced support technicians (or any other type of individual or user).

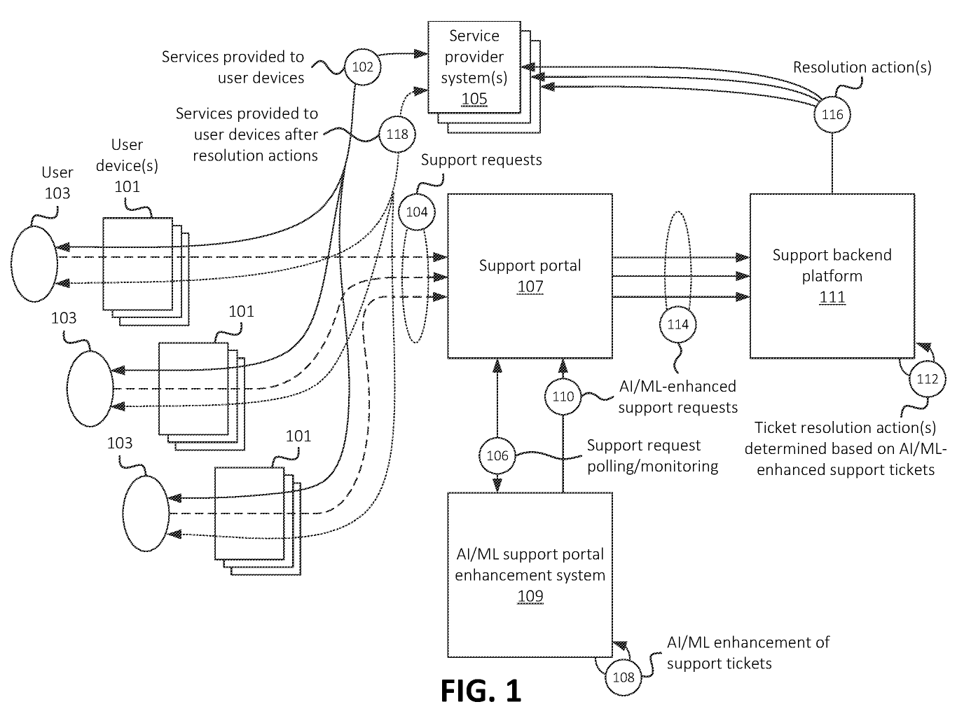

As shown in FIG. 1, for example, respective sets of user devices 101 may be associated with (e.g., used by, provided by, accessible to, or otherwise associated with) one or more users 103. In some embodiments, user devices 101 may include devices with network connectivity, such as a User Equipment ("UE") associated with a wireless network or some other suitable type of device. User devices 101 may receive (at 102) services from one or more service provider systems 105, which may include application servers, content provider systems, Multi-Access/Mobile Edge Computing ("MEC") devices, gaming servers, on-premises datacenters, cloud systems, videoconferencing service providers, and/or other types of devices or systems accessible via one or more networks, such as the Internet, one or more private networks, etc.

At some point in the course of receiving a service from a given service provider system 105, a particular user 103 may experience some type of technical issue, such as an issue with the service, which may include perceptible performance issues such as low bandwidth or high latency, "choppy" video, freezes or disconnects, or the like. Additionally, or alternatively, user 103 may experience an issue with user device 101 itself, or may not be aware of whether such issues are attributable to service provider system 105, user device 101, network connectivity between service provider system 105 and user device 101, or some other cause. Additionally, or alternatively, an application executing at user device 101 (e.g., a "client-side" application that communications with service provider system 105 that implements a corresponding "server-side" application) may identify an issue, such as one or more Quality of Service ("QoS") thresholds not being met, connectivity issues, or other types of issues.

User device 101 may provide (at 104) a support request (e.g., as initiated by user 103 and/or an application executing at user device 101) to support portal 107. Support portal 107 may implement or provide a web portal, an application, an application programming interface ("API"), and/or some other suitable communication pathway via which user devices 101 and support portal 107 communicate. In some embodiments, user devices 101 and/or users 103 may be registered with support portal 107 (e.g., prior to sending support requests to support portal 107). For example, support portal 107 may receive or maintain one or more identifiers associated with users 103 and associated user devices 101, including such as user names, device identifiers (e.g., International Mobile Subscriber Identity ("IMSI") values, International Mobile Station Equipment Identity ("IMEI") values, Mobile Directory Numbers ("MDNs"), Internet Protocol ("IP") addresses, etc.), and/or other suitable identifiers.

In some embodiments, support portal 107 may receive or maintain identifiers of particular service provider systems 105 that provide services to user devices 101, such as IP addresses, Uniform Resource Locators ("URLs"), Uniform Resource Identifiers ("URIs"), hostnames, device identifiers, or other suitable identifiers. Support portal 107 may, in this manner, maintain information associating particular user devices 101 and/or users 103 with service provider systems 105 that provide services to such user devices 101 and/or users 103. In some embodiments, support portal 107 may receive or maintain other information associated with user devices 101, service provider systems 105, and/or services associated therewith, such as performance metrics (e.g., throughput metrics, latency metrics, etc.), Key Performance Indicators ("KPIs"), usage metrics (e.g., an amount of traffic sent between respective user devices 101 and service provider systems 105), and/or other suitable information associated with user devices 101, users 103, and/or service provider systems 105. Support portal 107 may receive such information from user devices 101, service provider systems 105, and/or some other suitable source.

In this manner, support portal 107 may potentially receive (at 104) numerous support requests, such as from hundreds or thousands of users 103, over a relatively short time period. In accordance with some embodiments, AI/ML support enhancement system 109 may monitor, poll, etc. (at 106) support portal 107 for support requests received (at 104) by 107. For example, AI/ML support enhancement system 109 may periodically (e.g., every hour, every two hours, every four hours, every morning and afternoon, etc.), intermittently, on an event-driven basis, and/or on some other ongoing basis, request, obtain, or otherwise receive (at 106) information regarding support requests associated with one or more user devices 101 and/or users 103. In some embodiments, the frequency, interval, basis, etc. on which AI/ML support enhancement system 109 obtains or receives (at 106) the support request information may be modified, refined, etc. over time (e.g., using AI/ML techniques), in order to optimize the efficiency of AI/ML support enhancement system 109 including efficient use of network resources when obtaining the support request information.

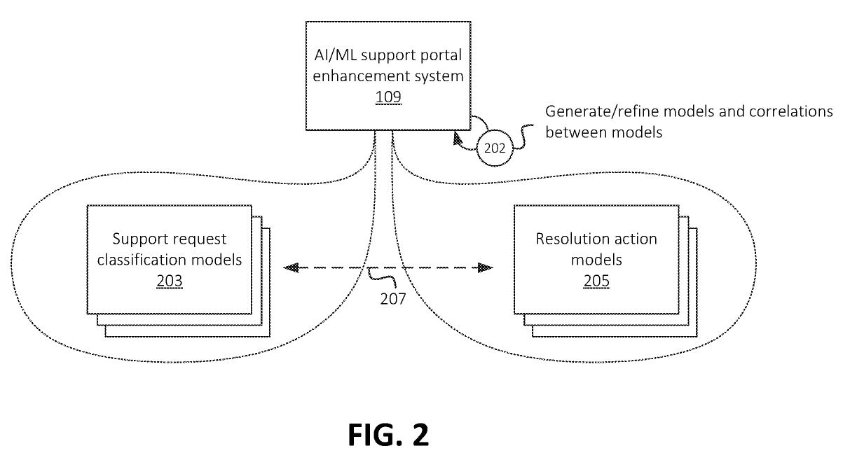

AI/ML support enhancement system 109 may further enhance (at 108) the received support tickets, using AI/ML techniques or other suitable automated techniques. In some embodiments, the AI/ML techniques may be used to identify a set of resolution actions to perform in order to resolve support requests that include or are associated with certain respective issues or other particular attributes of support requests. For example, as shown in FIG. 2, AI/ML support enhancement system 109 may receive, generate, and/or refine (at 202) one or more sets of models, and correlations between the models, based on which AI/ML support portal enhancement system 109 may identify optimal resolution actions to perform in response to support requests meeting certain parameters. As shown, for example, AI/ML support portal enhancement system 109 may receive, generate, maintain, etc. a set of support request classification models 203. Support request classification models 203 may be used to classify support requests into particular categories, types, or other respective classifications, which may ultimately be used to identify resolution actions based on such categories, types, etc. For example, as discussed below, support request classification models 203 may be correlated (at 207) with one or more resolution action models 205, which may indicate how such support requests should be resolved.

Support request classification models 203 may include attributes of support requests. In one example, the attributes of a support request may include content of the support request, such as key words, categories, labels, etc. that are explicitly included in support requests such as "choppy video" or "can't connect," or other information included in support requests. In some embodiments, the attributes of a support request may include a quantity of support requests submitted by a given user device 101 or user 103 over a given time frame, and/or user profile and/or history information of user 103 with which a support request is associated. In some embodiments, the attributes of a support request may include device attribute information (e.g., associated with a particular user device 101), such as location information of user device 101, device type of user device 101 (e.g., Internet of Things ("IoT") device, smartphone, Machine-to-Machine ("M2M") device, automated guided vehicle ("AGV"), etc.), mobile network operator ("MNO") identifier of home network with which user device 101 is associated, and/or other device attribute information. In some embodiments, the attributes of a support request may include an identifier of one or more applications (e.g., executing at user device 101) with which the support request is associated and/or an identifier of one or more service provider systems 105 (e.g., which provide a particular service that is a subject of the support request). In some embodiments, AI/ML support enhancement system 109 may generate, maintain, refine, etc. (at 202) support classification models 203 based on other attributes of support requests in addition to, or in lieu of, the examples provided above.

Classification models 203 may be received, generated, modified, etc. during a "training" phase associated with one or more AI/ML techniques, such as a random forest technique, a neural network technique, a supervised learning technique, an unsupervised learning technique, and/or some other suitable AI/ML training operation. For example, AI/ML support portal enhancement system 109 may perform one or more simulations of resolving support requests, having particular attributes, with using different candidate resolution actions, and may identify a measure of performance, user satisfaction, resource cost, optimality, associated with the different resolution actions. AI/ML support enhancement system 109 may identify a one or more resolution actions (e.g., a particular resolution action model 205) to perform based on, for example, the resolution action with the highest measure of performance, the highest measure of user satisfaction, the lowest resource cost, etc., and/or based on a combination of multiple factors associated with the candidate resolution actions.

Resolution action models 205 may include a set of actions to perform in order to resolve issues noted in support requests (e.g., support requests identified as being classified under one or more support classification models 203, as discussed above). Such resolution actions may include, for example, allocating additional network resources to one or more communication sessions associated with a given user device and/or service provider system 105, instructing service provider system 105 to modify one or more configuration parameters (e.g., a bit rate of streaming content provided to user device 101, a maximum amount of data to request from user device 101 over a given time frame, etc.), modifying one or more configuration parameters or other operations at user device 101 (e.g., changing one or more device settings, rebooting user device 101, installing or uninstalling an application, updating an application or API implemented at user device 101, etc.), and/or other types of actions. In some embodiments, AI/ML support enhancement system 109 may generate, maintain, refine, etc. (at 202) resolution action models 205 based on other attributes of support requests in addition to, or in lieu of, the examples provided above.

As noted above, AI/ML support portal enhancement system 109 may correlate (at 207) one or more support request classification models 203 to one or more resolution action models 205. In some embodiments, AI/ML support portal enhancement system 109 may use AI/ML techniques in order to correlate a given support request classification model 203 with a given resolution action model 205. For example, as noted above, AI/ML support portal enhancement system 109 may perform one or more simulations in order to determine a measure of optimality or other measures associated with performing particular resolution actions for support requests meeting the attributes of certain support classification models 203. Additionally, or alternatively, AI/ML support enhancement system 109 may receive real-world feedback information based on certain resolution actions being performed in response to support requests meeting certain attributes. The feedback information may include, for example, measured performance impact of performing a given resolution action, a user satisfaction score determined based on performing a given resolution action, an amount of time between receiving a given support request and determining that the support request has been resolved, and/or other suitable types of feedback information based on which AI/ML support enhancement system 109 may modify or refine the associations 207 of respective support classification models 203 and resolution action models 205.

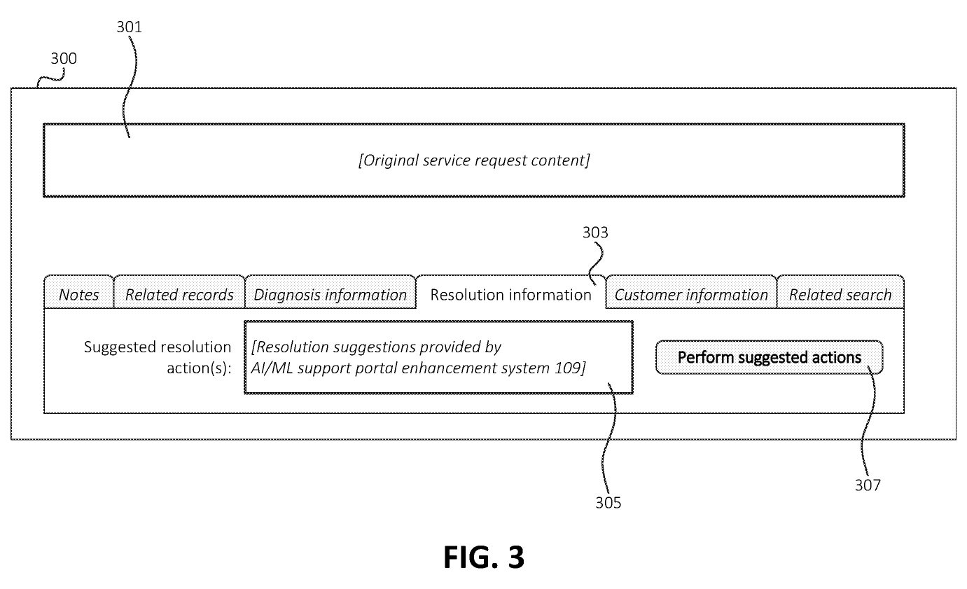

Returning to FIG. 1, AI/ML support enhancement system 109 may provide (at 110) AI/ML-enhanced support requests to support portal 107. In some embodiments, AI/ML-enhanced support requests may include an indication of identified resolution actions to perform, in addition to some or all of the original information itself. In this manner, support portal 107 may be able to provide (at 114) the AI/ML-enhanced support requests to support backend platform 111. In some embodiments, as shown in FIG. 3, support backend platform 111 may generate or provide UI 300, in association with a particular support request. In some embodiments, UI 300 may include one or more display area 301, which includes some or all of the content of the original service request (e.g., as received from a particular user device 101 and/or user 103). In some examples, display area 301 may include, for example, text provided by user 103, describing a particular issue. In some embodiments, display area 301 may include automatically determined or generated information, such as metadata (e.g., including a time the support request was sent, an identifier of user device 101 from which the support request was sent, an operating system of user device 101, and/or other suitable metadata).

In some embodiments, UI 300 may include display area 303, which may be associated with a particular tab in a tab group (e.g., a group of display areas that may be selected via clicking a particular tab). Display area 303 may include, for example, display area 305, which may indicate one or more resolution actions to perform for the indicated support request. As discussed above, the one or more resolution actions may have been selected by AI/ML support enhancement system 109 based on one or more support classification models 203, resolution action models 205, and/or associations 207 between support classification models 203 and resolution action models 205. In one example, UI 300 may be presented via a workstation, a display device, etc. to a support agent, who may be able to quickly ascertain the issue as well as the optimal solution to the issue (e.g., one or more resolution actions to perform, which were determined using AI/ML techniques).

In some embodiments, display area 303 may include selectable option 307, such as a button, which may be selected (e.g., by a support agent) to proceed with performing the suggested resolution action. For example, once the support agent has reviewed the details of the support request and has confirmed the suggested resolution action(s), the support agent may select selectable option 307, and such actions may be automatically performed without any further feedback from the support agent, thus reducing the workload on such support agents and ultimately enhancing the efficiency of support backend platform 111.

Returning to FIG. 1, for example, support backend platform 111 may determine (at 112) the resolution action(s) to perform with respect to a given support request based on, for example, a support agent indicating (e.g., via UI 300) the resolution action to perform (e.g., by confirming a suggested resolution action). In some embodiments, in addition to or in lieu of presenting the support request to a support agent, support backend platform 111 may automatically determine one or more resolution actions to perform, based on resolution action(s) indicated in a given AI/ML-enhanced support request (received at 114). For example, support backend platform 111 may identify that an example set of resolution actions to perform, as indicated in the AI/ML-enhanced support request, includes outputting one or more instructions, configuration modification parameters, and/or other information to one or more service provider systems 105 (e.g., which may be associated with a particular issue noted in the support request). Support backend platform 111 may accordingly provide (at 116) such instructions, configuration modification parameters, etc. to service provider system 105.

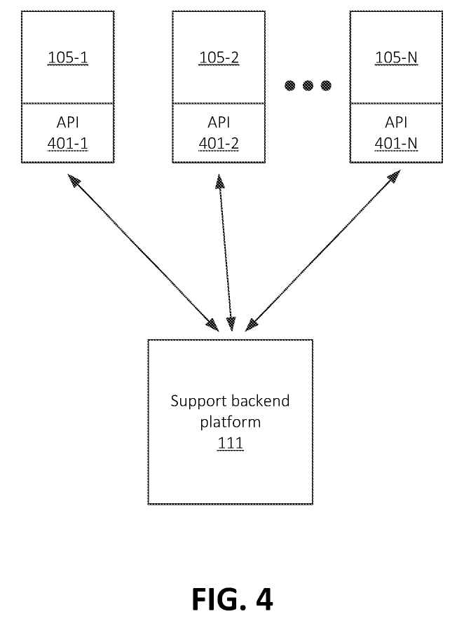

In some embodiments, as shown in FIG. 4, support backend platform 111 may communicate with service provider systems 105 via respective APIs 401. For example, support backend platform 111 may communicate with service provider system 105-1 via API 401-1, may communicate with service provider system 105-2 via API 401-2, may communicate with service provider system 105-N via API 401-N, and so on. As one example, when a given AI/ML-enhanced support request includes an indication that configuration parameters associated with a particular service provider system 105 (e.g., service provider system 105-2) should be modified, support backend platform 111 may communicate such modifications to service provider system 105-2 via API 401-2. In this manner, support backend platform 111 may be able to automatically effectuate changes to services provided by service provider systems 105.

As shown in FIG. 1, service provider systems 105 may implement such instructions, configuration modification parameters, etc., and may continue to provide (at 118) services to respective user devices 101 after implementing the instructions, configuration modification parameters, etc. The services may thus be provided (at 118) in an improved or remediated manner, inasmuch as issues that were noted in support requests (at 104) have been resolved.

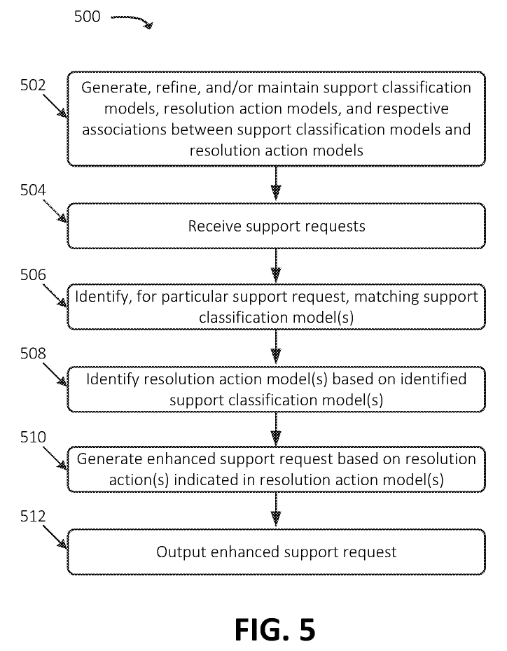

FIG. 5 illustrates an example process 500 for automatically enhancing support requests, in accordance with some embodiments. In some embodiments, some or all of process 500 may be performed by AI/ML support enhancement system 109.

As shown, process 500 may include generating, refining, maintaining, etc. (at 502) a set of support classification models 203, resolution action models 205, and respective associations 207 between support classification models 203 and resolution action models 205. For example, as discussed above with respect to FIG. 2, generating or refining support classification models 203 and/or resolution action models 205 may include utilizing AI/ML techniques, such as a random forest technique, a neural network technique, or other suitable AI/ML techniques. As discussed above, a particular resolution action model 205 with a relatively high measure of association 207 with a particular support classification model 203 may include one or more resolution actions that are optimal (e.g., as determined via one or more AI/ML training techniques such as supervised learning, unsupervised learning, etc.) for support requests that match support classification model 203.

Process 500 may further include receiving (at 504) one or more support requests. For example, as discussed above, AI/ML support enhancement system 109 may poll, monitor, etc. support portal 107 for support requests received (e.g., from user devices 101, users 103, etc.) over time, in order to stay up-to-date with respect to support requests received by support portal 107.

Process 500 may additionally include identifying (at 506), for a particular support request, one or more matching support classification models 203. For example, AI/ML support enhancement system 109 may utilize one or more AI/ML techniques to identify support classification models 203 with attributes that are match or are otherwise similar to (e.g., that are associated with at least a threshold measure of similarity based on a suitable similarity analysis or other type of comparison) attributes of the support request, such as support request content, information associated with a particular user device 101 or user 103 that submitted the support request, a time at which the support request was submitted, and/or other suitable information.

Process 500 may also include identifying (at 508) one or more resolution action models 205 based on the identified one or more support classification models 203. For example, AI/ML support enhancement system 109 may identify one or more resolution action models 205 that are associated with (e.g., with at least a threshold measure of association 207) support classification model 203. In some embodiments, AI/ML support enhancement system 109 may identify multiple resolution action models 205, which may be associated with multiple potential resolution actions to perform in order to resolve issues indicated in the support request. On the other hand, in some embodiments, AI/ML support enhancement system 109 may identify a single resolution action model 205 that is associated with support classification model 203 (e.g., the particular resolution action model 205 with a highest measure of association 207 with support classification model 203).

Process 500 may further include generating (at 510) an enhanced support request based on one or more resolution actions indicated in the one or more resolution action models 205. For example, AI/ML support enhancement system 109 may generate a support request that includes some or all of the content of the original support request, as well as additional content or information based on the identified resolution action(s). Process 500 may additionally include outputting (at 512) the enhanced support request. For example, as discussed above, outputting the enhanced support request may include outputting instructions to one or more service provider systems 105 to perform the identified resolution actions. Additionally, or alternatively, outputting the enhanced support request may include outputting the enhanced support request to support backend platform 111 for presentation (e.g., via UI 300) to one or more support technicians, who may utilize the enhanced support request to quickly resolve the issues noted in the original support request.

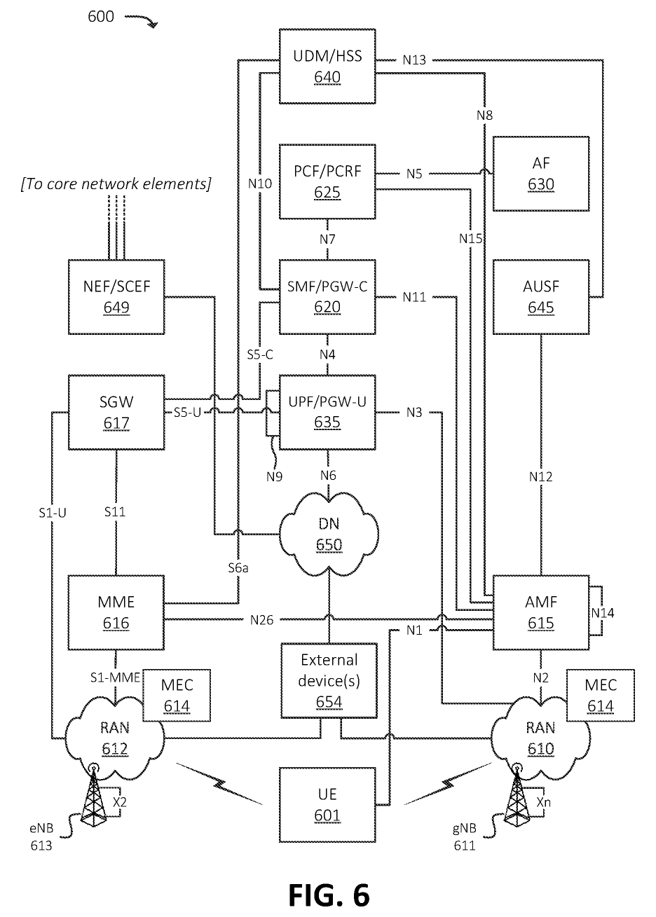

FIG. 6 illustrates an example environment 600, in which one or more embodiments may be implemented. In some embodiments, environment 600 may correspond to a Fifth Generation ("5G") network, and/or may include elements of a 5G network. In some embodiments, environment 600 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 600 may represent or may include a 5G core ("5GC"). As shown, environment 600 may include UE 601, RAN 610 (which may include one or more Next Generation Node Bs ("gNBs") 611), RAN 612 (which may include one or more evolved Node Bs ("eNBs") 613), and various network functions such as Access and Mobility Management Function ("AMF") 615, Mobility Management Entity ("MME") 616, Serving Gateway ("SGW") 617, Session Management Function ("SMF")/Packet Data Network ("PDN") Gateway ("PGW")-Control plane function ("PGW-C") 620, Policy Control Function ("PCF")/Policy Charging and Rules Function ("PCRF") 625, Application Function ("AF") 630, User Plane Function ("UPF")/PGW-User plane function ("PGW-U") 635, Unified Data Management ("UDM")/Home Subscriber Server ("HSS") 640, Authentication Server Function ("AUSF") 645, and Network Exposure Function ("NEF")/Service Capability Exposure Function ("SCEF") 649. Environment 600 may also include one or more networks, such as Data Network ("DN") 650. Environment 600 may include one or more additional devices or systems communicatively coupled to one or more networks (e.g., DN 650), such as one or more external devices 654.

The example shown in FIG. 6 illustrates one instance of each network component or function (e.g., one instance of SMF/PGW-C 620, PCF/PCRF 625, UPF/PGW-U 635, UDM/HSS 640, and/or AUSF 645). In practice, environment 600 may include multiple instances of such components or functions. For example, in some embodiments, environment 600 may include multiple "slices" of a core network, where each slice includes a discrete and/or logical set of network functions (e.g., one slice may include a first instance of AMF 615, SMF/PGW-C 620, PCF/PCRF 625, and/or UPF/PGW-U 635, while another slice may include a second instance of AMF 615, SMF/PGW-C 620, PCF/PCRF 625, and/or UPF/PGW-U 635). The different slices may provide differentiated levels of service, such as service in accordance with different Quality of Service ("QoS") parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Additionally, one or more elements of environment 600 may be implemented in a virtualized and/or containerized manner. For example, one or more of the elements of environment 600 may be implemented by one or more Virtualized Network Functions ("VNFs"), Cloud-Native Network Functions ("CNFs"), etc. In such embodiments, environment 600 may include, may implement, and/or may be communicatively coupled to an orchestration platform that provisions hardware resources, installs containers or applications, performs load balancing, and/or otherwise manages the deployment of such elements of environment 600. In some embodiments, such orchestration and/or management of such elements of environment 600 may be performed by, or in conjunction with, the open-source Kubernetes^{®} application programming interface ("API") or some other suitable virtualization, containerization, and/or orchestration system.

Elements of environment 600 may interconnect with each other and/or other devices via wired connections, wireless connections, or a combination of wired and wireless connections. Examples of interfaces or communication pathways between the elements of environment 600, as shown in FIG. 6, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 6, such as Service-Based Interfaces ("SBIs"), including an Namf interface, an Nudm interface, an Npcf interface, an Nupf interface, an Nnef interface, an Nsmf interface, and/or one or more other SBIs.

UE 601 may include a computation and communication device, such as a wireless mobile communication device that is capable of communicating with RAN 610, RAN 612, and/or DN 650. UE 601 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 601 may send traffic to and/or receive traffic (e.g., user plane traffic) from DN 650 via RAN 610, RAN 612, and/or UPF/PGW-U 635. In some embodiments, user device 101 may include, may implement, may be implemented by, and/or may be otherwise associated with UE 601.

RAN 610 may be, or may include, a 5G RAN that implements a 5G RAT and that includes one or more base stations (e.g., one or more gNBs 611), via which UE 601 may communicate with one or more other elements of environment 600. UE 601 may communicate with RAN 610 via an air interface (e.g., as provided by gNB 611). For instance, RAN 610 may receive traffic (e.g., user plane traffic such as voice call traffic, data traffic, messaging traffic, etc.) from UE 601 via the air interface, and may communicate the traffic to UPF/PGW-U 635 and/or one or more other devices or networks. Further, RAN 610 may receive signaling traffic, control plane traffic, etc. from UE 601 via the air interface, and may communicate such signaling traffic, control plane traffic, etc. to AMF 615 and/or one or more other devices or networks. Additionally, RAN 610 may receive traffic intended for UE 601 (e.g., from UPF/PGW-U 635, AMF 615, and/or one or more other devices or networks) and may communicate the traffic to UE 601 via the air interface.

RAN 612 may be, or may include, an LTE RAN that implements an LTE RAT and that includes one or more base stations (e.g., one or more eNBs 613), via which UE 601 may communicate with one or more other elements of environment 600. UE 601 may communicate with RAN 612 via an air interface (e.g., as provided by eNB 613). For instance, RAN 612 may receive traffic (e.g., user plane traffic such as voice call traffic, data traffic, messaging traffic, signaling traffic, etc.) from UE 601 via the air interface, and may communicate the traffic to UPF/PGW-U 635 (e.g., via SGW 617) and/or one or more other devices or networks. Further, RAN 612 may receive signaling traffic, control plane traffic, etc. from UE 601 via the air interface, and may communicate such signaling traffic, control plane traffic, etc. to MME 616 and/or one or more other devices or networks. Additionally, RAN 612 may receive traffic intended for UE 601 (e.g., from UPF/PGW-U 635, MME 616, SGW 617, and/or one or more other devices or networks) and may communicate the traffic to UE 601 via the air interface.

One or more RANs of environment 600 (e.g., RAN 610 and/or RAN 612) may include, may implement, and/or may otherwise be communicatively coupled to one or more edge computing devices, such as one or more MEC devices (referred to sometimes herein simply as a "MECs") 614. MECs 614 may be co-located with wireless network infrastructure equipment of RANs 610 and/or 612 (e.g., one or more gNBs 611 and/or one or more eNBs 613, respectively). Additionally, or alternatively, MECs 614 may otherwise be associated with geographical regions (e.g., coverage areas) of wireless network infrastructure equipment of RANs 610 and/or 612. In some embodiments, one or more MECs 614 may be implemented by the same set of hardware resources, the same set of devices, etc. that implement wireless network infrastructure equipment of RANs 610 and/or 612. In some embodiments, one or more MECs 614 may be implemented by different hardware resources, a different set of devices, etc. from hardware resources or devices that implement wireless network infrastructure equipment of RANs 610 and/or 612. In some embodiments, MECs 614 may be communicatively coupled to wireless network infrastructure equipment of RANs 610 and/or 612 (e.g., via a high-speed and/or low-latency link such as a physical wired interface, a high-speed and/or low-latency wireless interface, or some other suitable communication pathway).

MECs 614 may include hardware resources (e.g., configurable or provisionable hardware resources) that may be configured to provide services and/or otherwise process traffic to and/or from UE 601, via RAN 610 and/or 612. For example, RAN 610 and/or 612 may route some traffic from UE 601 (e.g., traffic associated with one or more particular services, applications, application types, etc.) to a respective MEC 614 instead of to core network elements of 600 (e.g., UPF/PGW-U 635). MEC 614 may accordingly provide services to UE 601 by processing such traffic, performing one or more computations based on the received traffic, and providing traffic to UE 601 via RAN 610 and/or 612. MEC 614 may include, and/or may implement, some or all of the functionality described above with respect to support portal 107, AI/ML support enhancement system 109, support backend platform 111, UPF/PGW-U 635, AF 630, one or more application servers, and/or one or more other devices, systems, VNFs, CNFs, etc. In this manner, ultra-low latency services may be provided to UE 601, as traffic does not need to traverse links (e.g., backhaul links) between RAN 610 and/or 612 and the core network.

AMF 615 may include one or more devices, systems, VNFs, CNFs, etc., that perform operations to register UE 601 with the 5G network, to establish bearer channels associated with a session with UE 601, to hand off UE 601 from the 5G network to another network, to hand off UE 601 from the other network to the 5G network, manage mobility of UE 601 between RANs 610 and/or gNBs 611, and/or to perform other operations. In some embodiments, the 5G network may include multiple AMFs 615, which communicate with each other via the N14 interface (denoted in FIG. 6 by the line marked "N14" originating and terminating at AMF 615).

MME 616 may include one or more devices, systems, VNFs, CNFs, etc., that perform operations to register UE 601 with the EPC, to establish bearer channels associated with a session with UE 601, to hand off UE 601 from the EPC to another network, to hand off UE 601 from another network to the EPC, manage mobility of UE 601 between RANs 612 and/or eNBs 613, and/or to perform other operations.

SGW 617 may include one or more devices, systems, VNFs, CNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, CNFs, etc., that gather, process, store, and/or provide information in a manner described herein. SMF/PGW-C 620 may, for example, facilitate the establishment of communication sessions on behalf of UE 601. In some embodiments, the establishment of communications sessions may be performed in accordance with one or more policies provided by PCF/PCRF 625.

PCF/PCRF 625 may include one or more devices, systems, VNFs, CNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625).

AF 630 may include one or more devices, systems, VNFs, CNFs, etc., that receive, store, and/or provide information that may be used in determining parameters (e.g., quality of service parameters, charging parameters, or the like) for certain applications.

UPF/PGW-U 635 may include one or more devices, systems, VNFs, CNFs, etc., that receive, store, and/or provide data (e.g., user plane data). For example, UPF/PGW-U 635 may receive user plane data (e.g., voice call traffic, data traffic, etc.), destined for UE 601, from DN 650, and may forward the user plane data toward UE 601 (e.g., via RAN 610, SMF/PGW-C 620, and/or one or more other devices). In some embodiments, multiple instances of UPF/PGW-U 635 may be deployed (e.g., in different geographical locations), and the delivery of content to UE 601 may be coordinated via the N9 interface (e.g., as denoted in FIG. 6 by the line marked "N9" originating and terminating at UPF/PGW-U 635). Similarly, UPF/PGW-U 635 may receive traffic from UE 601 (e.g., via RAN 610, RAN 612, SMF/PGW-C 620, and/or one or more other devices), and may forward the traffic toward DN 650. In some embodiments, UPF/PGW-U 635 may communicate (e.g., via the N4 interface) with SMF/PGW-C 620, regarding user plane data processed by UPF/PGW-U 635.

UDM/HSS 640 and AUSF 645 may include one or more devices, systems, VNFs, CNFs, etc., that manage, update, and/or store, in one or more memory devices associated with AUSF 645 and/or UDM/HSS 640, profile information associated with a subscriber. In some embodiments, UDM/HSS 640 may include, may implement, may be communicatively coupled to, and/or may otherwise be associated with some other type of repository or database, such as a Unified Data Repository ("UDR"). AUSF 645 and/or UDM/HSS 640 may perform authentication, authorization, and/or accounting operations associated with one or more UEs 601 and/or one or more communication sessions associated with one or more UEs 601.

DN 650 may include one or more wired and/or wireless networks. For example, DN 650 may include an Internet Protocol ("IP")-based PDN, a wide area network ("WAN") such as the Internet, a private enterprise network, and/or one or more other networks. UE 601 may communicate, through DN 650, with data servers, other UEs 601, and/or to other servers or applications that are coupled to DN 650. DN 650 may be connected to one or more other networks, such as a public switched telephone network ("PSTN"), a public land mobile network ("PLMN"), and/or another network. DN 650 may be connected to one or more devices, such as content providers, applications, web servers, and/or other devices, with which UE 601 may communicate.

External devices 654 may include one or more devices or systems that communicate with UE 601 via DN 650 and one or more elements of 600 (e.g., via UPF/PGW-U 635). In some embodiments, external devices 654 may include, may implement, and/or may otherwise be associated with support portal 107, AI/ML support enhancement system 109, and/or support backend platform 111. External devices 654 may include, for example, one or more service provider systems 105, application servers, content provider systems, web servers, or the like. External devices 654 may, for example, implement "server-side" applications that communicate with "client-side" applications executed by UE 601. External devices 654 may provide services to UE 601 such as gaming services, videoconferencing services, messaging services, email services, web services, and/or other types of services. Operations described above with respect to a given external device 654 (e.g., in accordance with some embodiments) may be performed by a single device, by a cloud computing system, by one or more devices that implement a virtualized or containerized environment, a collection of devices, etc.

In some embodiments, external devices 654 may communicate with one or more elements of environment 600 (e.g., core network elements) via NEF/SCEF 649. NEF/SCEF 649 include one or more devices, systems, VNFs, CNFs, etc. that provide access to information, APIs, and/or other operations or mechanisms of one or more core network elements to devices or systems that are external to the core network (e.g., to external device 654 via DN 650). NEF/SCEF 649 may maintain authorization and/or authentication information associated with such external devices or systems, such that NEF/SCEF 649 is able to provide information, that is authorized to be provided, to the external devices or systems. For example, a given external device 654 may request particular information associated with one or more core network elements. NEF/SCEF 649 may authenticate the request and/or otherwise verify that external device 654 is authorized to receive the information, and may request, obtain, or otherwise receive the information from the one or more core network elements. In some embodiments, NEF/SCEF 649 may include, may implement, may be implemented by, may be communicatively coupled to, and/or may otherwise be associated with a Security Edge Protection Proxy ("SEPP"), which may perform some or all of the functions discussed above. External device 654 may, in some situations, subscribe to particular types of requested information provided by the one or more core network elements, and the one or more core network elements may provide (e.g., "push") the requested information to NEF/SCEF 649 (e.g., in a periodic or otherwise ongoing basis).

In some embodiments, external devices 654 may communicate with one or more elements of RAN 610 and/or 612 via an API or other suitable interface. For example, a given external device 654 may provide instructions, requests, etc. to RAN 610 and/or 612 to provide one or more services via one or more respective MECs 614. In some embodiments, such instructions, requests, etc. may include QoS parameters, Service Level Agreements ("SLAs"), etc. (e.g., maximum latency thresholds, minimum throughput thresholds, etc.) associated with the services.

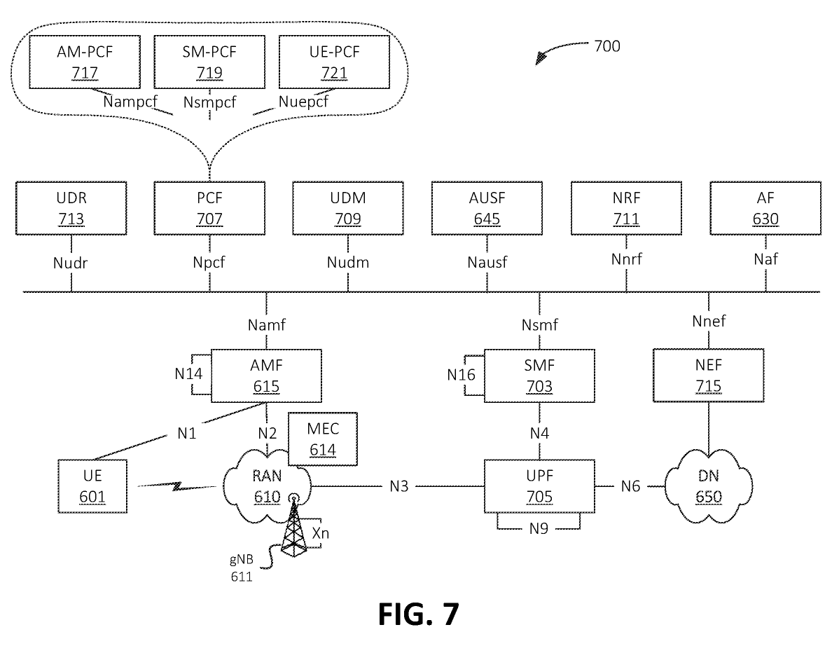

FIG. 7 illustrates another example environment 700, in which one or more embodiments may be implemented. In some embodiments, environment 700 may correspond to a 5G network, and/or may include elements of a 5G network. In some embodiments, environment 700 may correspond to a 5G SA architecture. In some embodiments, environment 700 may include a 5GC, in which 5GC network elements perform one or more operations described herein.

As shown, environment 700 may include UE 601, RAN 610 (which may include one or more gNBs 611 or other types of wireless network infrastructure) and various network functions, which may be implemented as VNFs, CNFs, etc. Such network functions may include AMF 615, SMF 703, UPF 705, PCF 707, UDM 709, AUSF 645, Network Repository Function ("NRF") 711, AF 630, UDR 713, and NEF 715. Environment 700 may also include or may be communicatively coupled to one or more networks, such as DN 650.

The example shown in FIG. 7 illustrates one instance of each network component or function (e.g., one instance of SMF 703, UPF 705, PCF 707, UDM 709, AUSF 645, etc.). In practice, environment 700 may include multiple instances of such components or functions. For example, in some embodiments, environment 700 may include multiple "slices" of a core network, where each slice includes a discrete and/or logical set of network functions (e.g., one slice may include a first instance of SMF 703, PCF 707, UPF 705, etc., while another slice may include a second instance of SMF 703, PCF 707, UPF 705, etc.). Additionally, or alternatively, one or more of the network functions of environment 700 may implement multiple network slices. The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include interfaces shown in FIG. 7 and/or one or more interfaces not explicitly shown in FIG. 7. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 700 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 615), an Nudm interface (e.g., indicating communications to be routed to UDM 709), an Npcf interface, an Nupf interface, an Nnef interface, an Nsmf interface, an Nnrf interface, an Nudr interface, an Naf interface, and/or one or more other SBIs.

UPF 705 may include one or more devices, systems, VNFs, CNFs, etc., that receive, route, process, and/or forward traffic (e.g., user plane traffic). As discussed above, UPF 705 may communicate with UE 601 via one or more communication sessions, such as PDU sessions. Such PDU sessions may be associated with a particular network slice or other suitable QoS parameters, as noted above. UPF 705 may receive downlink user plane traffic (e.g., voice call traffic, data traffic, etc. destined for UE 601) from DN 650, and may forward the downlink user plane traffic toward UE 601 (e.g., via RAN 610). In some embodiments, multiple UPFs 705 may be deployed (e.g., in different geographical locations), and the delivery of content to UE 601 may be coordinated via the N9 interface. Similarly, UPF 705 may receive uplink traffic from UE 601 (e.g., via RAN 610), and may forward the traffic toward DN 650. In some embodiments, UPF 705 may implement, may be implemented by, may be communicatively coupled to, and/or may otherwise be associated with UPF/PGW-U 635. In some embodiments, UPF 705 may communicate (e.g., via the N4 interface) with SMF 703, regarding user plane data processed by UPF 705 (e.g., to provide analytics or reporting information, to receive policy and/or authorization information, etc.).

PCF 707 may include one or more devices, systems, VNFs, CNFs, etc., that aggregate, derive, generate, etc. policy information associated with the 5GC and/or UEs 601 that communicate via the 5GC and/or RAN 610. PCF 707 may receive information regarding policies and/or subscriptions from one or more sources, such as subscriber databases (e.g., UDM 709, UDR 713, etc.), and/or from one or more users such as, for example, an administrator associated with PCF 707. In some embodiments, the functionality of PCF 707 may be split into multiple network functions or subsystems, such as access and mobility PCF ("AM-PCF") 717, session management PCF ("SM-PCF") 719, UE PCF ("UE-PCF") 721, and so on. Such different "split" PCFs may be associated with respective SBIs (e.g., AM-PCF 717 may be associated with an Nampcf SBI, SM-PCF 719 may be associated with an Nsmpcf SBI, UE-PCF 721 may be associated with an Nuepcf SBI, and so on) via which other network functions may communicate with the split PCFs. The split PCFs may maintain information regarding policies associated with different devices, systems, and/or network functions.

NRF 711 may include one or more devices, systems, VNFs, CNFs, etc. that maintain routing and/or network topology information associated with the 5GC. For example, NRF 711 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 713 may include one or more devices, systems, VNFs, CNFs, etc. that provide user and/or subscriber information, based on which PCF 707 and/or other elements of environment 700 may determine access policies, QoS policies, charging policies, or the like. In some embodiments, UDR 713 may receive such information from UDM 709 and/or one or more other sources.

NEF 715 include one or more devices, systems, VNFs, CNFs, etc. that provide access to information, APIs, and/or other operations or mechanisms of the 5GC to devices or systems that are external to the 5GC. NEF 715 may maintain authorization and/or authentication information associated with such external devices or systems, such that NEF 715 is able to provide information, that is authorized to be provided, to the external devices or systems. Such information may be received from other network functions of the 5GC (e.g., as authorized by an administrator or other suitable entity associated with the 5GC), such as SMF 703, UPF 705, a charging function ("CHF") of the 5GC, and/or other suitable network function. NEF 715 may communicate with external devices or systems (e.g., external devices 654) via DN 650 and/or other suitable communication pathways.

While environment 700 is described in the context of a 5GC, as noted above, environment 700 may, in some embodiments, include or implement one or more other types of core networks. For example, in some embodiments, environment 700 may be or may include a converged packet core, in which one or more elements may perform some or all of the functionality of one or more 5GC network functions and/or one or more EPC network functions. For example, in some embodiments, AMF 615 may include, may implement, may be implemented by, and/or may otherwise be associated with MME 616; SMF 703 may include, may implement, may be implemented by, and/or may otherwise be associated with SGW 617; PCF 707 may include, may implement, may be implemented by, and/or may otherwise be associated with a PCRF (e.g., PCF/PCRF 625); NEF 715 may include, may implement, may be implemented by, and/or may otherwise be associated with a SCEF (e.g., NEF/SCEF 649); and so on.

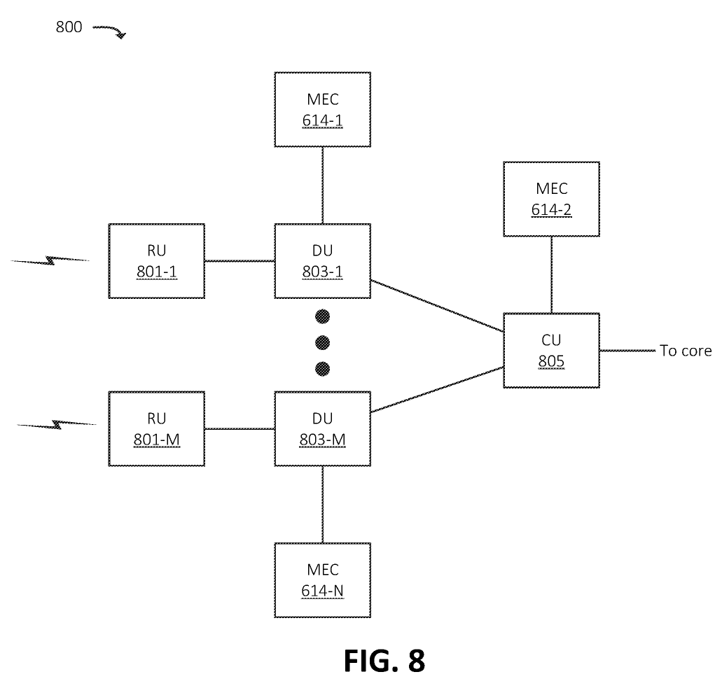

FIG. 8 illustrates an example RAN environment 800, which may be included in and/or implemented by one or more RANs (e.g., RAN 610 or some other RAN). In some embodiments, a particular RAN 610 may include one RAN environment 800. In some embodiments, a particular RAN 610 may include multiple RAN environments 800. In some embodiments, RAN environment 800 may correspond to a particular gNB 611 of RAN 610. In some embodiments, RAN environment 800 may correspond to multiple gNBs 611. In some embodiments, RAN environment 800 may correspond to one or more other types of base stations of one or more other types of RANs. As shown, RAN environment 800 may include Central Unit ("CU") 805, one or more Distributed Units ("DUs") 803-1 through 803-M (referred to individually as "DU 803," or collectively as "DUs 803"), and one or more Radio Units ("RUs") 801-1 through 801-M (referred to individually as "RU 801," or collectively as "RUs 801").

CU 805 may communicate with a core of a wireless network (e.g., may communicate with one or more of the devices or systems described above with respect to FIG. 7, such as AMF 615 and/or UPF 705) and/or some other device or system such as MEC 614. In the uplink direction (e.g., for traffic from UEs 601 to a core network), CU 805 may aggregate traffic from DUs 803, and forward the aggregated traffic to the core network. In some embodiments, CU 805 may receive traffic according to a given protocol (e.g., Radio Link Control ("RLC") traffic) from DUs 803, and may perform higher-layer processing (e.g., may aggregate/process RLC packets and generate Packet Data Convergence Protocol ("PDCP") packets based on the RLC packets) on the traffic received from DUs 803.

CU 805 may receive downlink traffic (e.g., traffic from the core network, traffic from a given MEC 614, etc.) for a particular UE 601, and may determine which DU(s) 803 should receive the downlink traffic. DU 803 may include one or more devices that transmit traffic between a core network (e.g., via CU 805) and UE 601 (e.g., via a respective RU 801). DU 803 may, for example, receive traffic from RU 801 at a first layer (e.g., physical ("PHY") layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 601.

RU 801 may include hardware circuitry (e.g., one or more RF transceivers, antennas, radios, and/or other suitable hardware) to communicate wirelessly (e.g., via an RF interface) with one or more UEs 601, one or more other DUs 803 (e.g., via RUs 801 associated with DUs 803), and/or any other suitable type of device. In the uplink direction, RU 801 may receive traffic from UE 601 and/or another DU 803 via the RF interface and may provide the traffic to DU 803. In the downlink direction, RU 801 may receive traffic from DU 803, and may provide the traffic to UE 601 and/or another DU 803.

One or more elements of RAN environment 800 may, in some embodiments, be communicatively coupled to one or more MECs 614. For example, DU 803-1 may be communicatively coupled to MEC 614-1, DU 803-M may be communicatively coupled to MEC 614-N, CU 805 may be communicatively coupled to MEC 614-2, and so on. MECs 614 may include hardware resources (e.g., configurable or provisionable hardware resources) that may be configured to provide services and/or otherwise process traffic to and/or from UE 601, via a respective RU 801.

For example, DU 803-1 may route some traffic, from UE 601, to MEC 614-1 instead of to a core network via CU 805. MEC 614-1 may process the traffic, perform one or more computations based on the received traffic, and may provide traffic to UE 601 via RU 801-1. As discussed above, MEC 614 may include, and/or may implement, some or all of the functionality described above with respect to UPF 705, AF 630, and/or one or more other devices, systems, VNFs, CNFs, etc. In this manner, ultra-low latency services may be provided to UE 601, as traffic does not need to traverse DU 803, CU 805, links between DU 803 and CU 805, and an intervening backhaul network between RAN environment 800 and the core network.

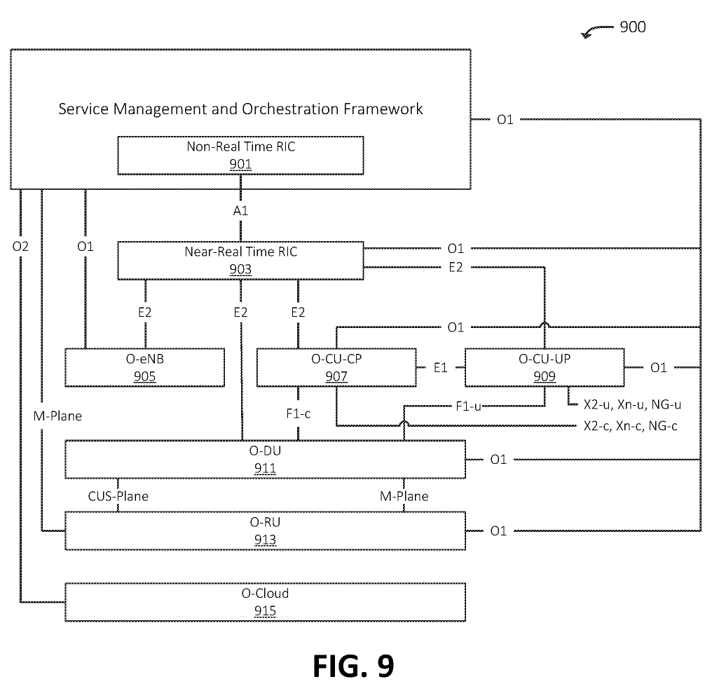

FIG. 9 illustrates an example O-RAN environment 900, which may correspond to RAN 610, RAN 612, and/or RAN environment 800. For example, RAN 610, RAN 612, and/or RAN environment 800 may include one or more instances of O-RAN environment 900, and/or one or more instances of O-RAN environment 900 may implement RAN 610, RAN 612, RAN environment 800, and/or some portion thereof. As shown, O-RAN environment 900 may include Non-Real Time Radio Intelligent Controller ("RIC") 901, Near-Real Time RIC 903, O-eNB 905, O-CU-Control Plane ("O-CU-CP") 907, O-CU-User Plane ("O-CU-UP") 909, O-DU 911, O-RU 913, and O-Cloud 915. In some embodiments, O-RAN environment 900 may include additional, fewer, different, and/or differently arranged components or interfaces.

In some embodiments, some or all of the elements of O-RAN environment 900 may be implemented by one or more configurable or provisionable resources, such as virtual machines, cloud computing systems, physical servers, and/or other types of configurable or provisionable resources. In some embodiments, some or all of O-RAN environment 900 may be implemented by, and/or communicatively coupled to, one or more MECs 614.

Non-Real Time RIC 901 and Near-Real Time RIC 903 may receive performance information (and/or other types of information) from one or more sources, and may configure other elements of O-RAN environment 900 based on such performance or other information. For example, Near-Real Time RIC 903 may receive performance information, via one or more E2 interfaces, from O-eNB 905, O-CU-CP 907, and/or O-CU-UP 909, and may modify parameters associated with O-eNB 905, O-CU-CP 907, and/or O-CU-UP 909 based on such performance information. Similarly, Non-Real Time RIC 901 may receive performance information associated with O-eNB 905, O-CU-CP 907, O-CU-UP 909, and/or one or more other elements of O-RAN environment 900 and may utilize machine learning and/or other higher level computing or processing to determine modifications to the configuration of O-eNB 905, O-CU-CP 907, O-CU-UP 909, and/or other elements of O-RAN environment 900. In some embodiments, Non-Real Time RIC 901 may generate machine learning models based on performance information associated with O-RAN environment 900 or other sources, and may provide such models to Near-Real Time RIC 903 for implementation.

In some embodiments, Non-Real Time RIC 901 may include, may implement, may be implemented by, and/or may otherwise be associated with AI/ML support enhancement system 109. In some embodiments, outputting (e.g., at 116) instructions to perform resolution actions may include outputting such instructions, or other indications of resolution actions, to Non-Real Time RIC 901 and/or to Near-Real Time RIC 903 for implementation at environment 900. In other words, modifying parameters associated with services provided to user devices 101 may include modifying O-RAN network parameters of environment 900.

O-eNB 905 may perform functions similar to those described above with respect to gNB 611 and/or eNB 613. For example, O-eNB 905 may facilitate wireless communications between UE 601 and a core network. O-CU-CP 907 may perform control plane signaling to coordinate the aggregation and/or distribution of traffic via one or more DUs 803, which may include and/or be implemented by one or more O-DUs 911, and O-CU-UP 909 may perform the aggregation and/or distribution of traffic via such DUs 803 (e.g., O-DUs 911). O-DU 911 may be communicatively coupled to one or more RUs 801, which may include and/or may be implemented by one or more O-RUs 913. In some embodiments, O-Cloud 915 may include or be implemented by one or more MECs 614, which may provide services, and may be communicatively coupled, to O-CU-CP 907, O-CU-UP 909, O-DU 911, and/or O-RU 913 (e.g., via an O1 and/or O2 interface).

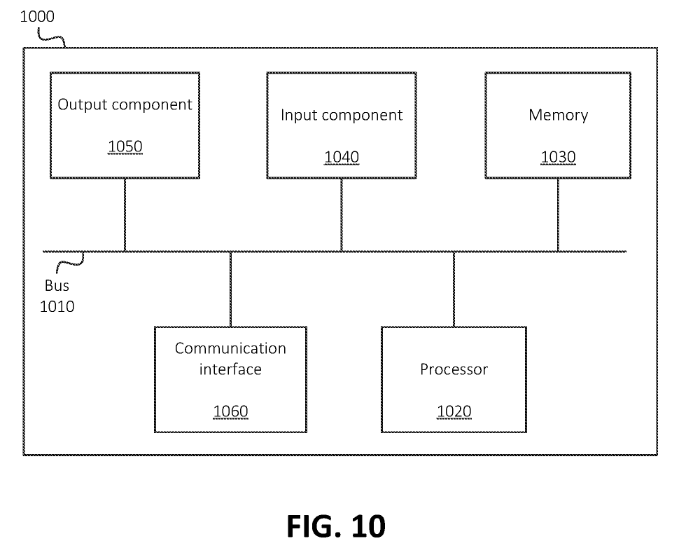

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes ("LEDs"), etc.

Communication interface 1060 may include any transceiver-like mechanism that enables device 1000 to communicate with other devices and/or systems (e.g., via RAN 610, RAN 612, DN 650, etc.). For example, communication interface 1060 may include an Ethernet interface, an optical interface, a coaxial interface, or the like. Communication interface 1060 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
maintain a plurality of support classification models and a plurality of resolution action models;
determine respective associations between the plurality of support classification models and the plurality of resolution action models;
receive a plurality of support requests;
identify a particular support classification model, of the plurality of support classification models, that is associated with a particular support request of the plurality of support requests;
identify, based on the determined associations between the plurality of support classification models and the plurality of resolution action models, a particular resolution action model associated with the particular support classification model;
identify one or more resolution actions associated with the particular resolution action model;
generate an enhanced support request based on the one or more resolution actions; and
output the enhanced support request.

2. The device of claim 1, wherein generating the enhanced support request includes generating one or more instructions to perform the one or more resolution actions, and wherein outputting the enhanced support request includes outputting the enhanced support request to one or more service provider systems.

3. The device of claim 2, wherein the particular support request includes an identifier of the one or more service provider systems, wherein outputting the enhanced support request to the one or more service provider systems is performed based on the identifier included in the particular support request.

4. The device of claim 2, wherein the one or more processors are further configured to:
implement an application programming interface ("API") associated with the one or more service provider systems, wherein outputting the enhanced support request includes outputting the enhanced support request via the API.

5. The device of claim 1, wherein generating the enhanced support request includes generating one or more descriptions associated with the one or more resolution actions, and wherein outputting the enhanced support requests includes outputting the enhanced support request to a support backend platform.

6. The device of claim 5, wherein the support backend platform presents a user interface ("UI") that includes the one or more descriptions associated with the one or more resolution actions.

7. The device of claim 6, wherein the UI further includes a selectable option to automatically perform the one or more resolution actions.

8. A non-transitory computer-readable medium, storing a plurality of processor-executable instructions to:
maintain a plurality of support classification models and a plurality of resolution action models;
determine respective associations between the plurality of support classification models and the plurality of resolution action models;
receive a plurality of support requests;
identify a particular support classification model, of the plurality of support classification models, that is associated with a particular support request of the plurality of support requests;
identify, based on the determined associations between the plurality of support classification models and the plurality of resolution action models, a particular resolution action model associated with the particular support classification model;
identify one or more resolution actions associated with the particular resolution action model;
generate an enhanced support request based on the one or more resolution actions; and
output the enhanced support request.

9. The non-transitory computer-readable medium of claim 8, wherein generating the enhanced support request includes generating one or more instructions to perform the one or more resolution actions, and wherein outputting the enhanced support request includes outputting the enhanced support request to one or more service provider systems.

10. The non-transitory computer-readable medium of claim 9, wherein the particular support request includes an identifier of the one or more service provider systems, wherein outputting the enhanced support request to the one or more service provider systems is performed based on the identifier included in the particular support request.

11. The non-transitory computer-readable medium of claim 9, wherein the plurality of processor-executable instructions further include processor-executable instructions to:
implement an application programming interface ("API") associated with the one or more service provider systems, wherein outputting the enhanced support request includes outputting the enhanced support request via the API.

12. The non-transitory computer-readable medium of claim 8, wherein generating the enhanced support request includes generating one or more descriptions associated with the one or more resolution actions, and wherein outputting the enhanced support requests includes outputting the enhanced support request to a support backend platform.

13. The non-transitory computer-readable medium of claim 12, wherein the support backend platform presents a user interface ("UI") that includes the one or more descriptions associated with the one or more resolution actions.

14. The non-transitory computer-readable medium of claim 13, wherein the UI further includes a selectable option to automatically perform the one or more resolution actions.

15. A method, comprising:
maintaining a plurality of support classification models and a plurality of resolution action models;
determining respective associations between the plurality of support classification models and the plurality of resolution action models;
receiving a plurality of support requests;
identifying a particular support classification model, of the plurality of support classification models, that is associated with a particular support request of the plurality of support requests;
identifying, based on the determined associations between the plurality of support classification models and the plurality of resolution action models, a particular resolution action model associated with the particular support classification model;
identifying one or more resolution actions associated with the particular resolution action model;
generating an enhanced support request based on the one or more resolution actions; and
outputting the enhanced support request.

16. The method of claim 15, wherein generating the enhanced support request includes generating one or more instructions to perform the one or more resolution actions, and wherein outputting the enhanced support request includes outputting the enhanced support request to one or more service provider systems.

17. The method of claim 16, wherein the particular support request includes an identifier of the one or more service provider systems, wherein outputting the enhanced support request to the one or more service provider systems is performed based on the identifier included in the particular support request.

18. The method of claim 16, further comprising:
implement an application programming interface ("API") associated with the one or more service provider systems, wherein outputting the enhanced support request includes outputting the enhanced support request via the API.

19. The method of claim 15, wherein generating the enhanced support request includes generating one or more descriptions associated with the one or more resolution actions, and wherein outputting the enhanced support requests includes outputting the enhanced support request to a support backend platform.

20. The method of claim 19, wherein the support backend platform presents a user interface ("UI") that includes:
the one or more descriptions associated with the one or more resolution actions, and
a selectable option to automatically perform the one or more resolution actions.
